(19) United States
(12) Patent Application Publication
(10) Pub. No.: US 2019/0132613 A1
(43) Pub. Date: May 2, 2019

(54) SYSTEMS AND ASSOCIATED METHODS FOR LIVE BROADCASTING

(71) Applicant: Chengdu CK Technology CO., LTD., Chengdu (CN)

(72) Inventors: Song Jiao, Chengdu (CN); Shu Liu, Chengdu (CN)

(21) Appl. No.: 16/088,422

(22) PCT Filed: Mar. 31, 2017
(86) PCT No.: PCT/CN2017/079001

§ 371 Date: Sep. 25, 2018

(30) Foreign Application Priority Data
Mar. 31, 2016 (CN) 201610197811.4
Mar. 31, 2016 (CN) 201610197812.9
Mar. 31, 2016 (CN) 201610197813.3
Mar. 31, 2016 (CN) 201610197814.8

(51) Int. Cl. H04N 21/2187; H04L 29/06

(52) U.S. Cl. CPC H04N 21/2187; H04L 65/4076

(57) ABSTRACT

The present disclosure relates to methods and associated systems that enable a user to live broadcast a set of images (e. g., videos). The method includes, for example, (1) receiving an instruction generated by a user clicking a button on a first device, wherein the first device is configured to capture and transmit live stream images; (2) suspending at least one existing application and initiating an live broadcast application in the first device; (3) detecting and choosing a data transmission access route to a remote live broadcast server; (4) establishing a connection to the remote live broadcast server via the data transmission access route; (5) sending account information to the remote live broadcast server; (6) receiving a token from the remote live broadcast server by the first device if the account information passes a live broadcast authentication of the remote live broadcast server; (7) requesting a live broadcast from the remote server and receiving a data transmission address from the remote server; and (8) transmitting the live stream images to the data transmission address via the data transmission access route.

### CROSS-REFERENCE TO RELATED APPLICATIONS

This application claims the benefit of Chinese Patent Application No. 2016101978129, filed Mar. 31, 2016 and entitled “METHODS FOR MULTI-ACCOUNT LIVE BROADCASTING VIA SPORTS CAMERA,” Chinese Patent Application No. 2016101978148, filed Mar. 31, 2016 and entitled “METHODS FOR LIVE BROADCASTING VIA SPORTS CAMERA USING WIRELESS NETWORK AND ASSOCIATED LIVE BROADCASTING ACCOUNTS,” Chinese Patent Application No. 2016101978114, filed Mar. 31, 2016 and entitled “METHODS FOR LIVE BROADCASTING VIA MULTIPLE SPORTS CAMERAS THROUGH THE INTERNET,” and Chinese Patent Application No. 2016101978133, filed Mar. 31, 2016 and entitled “METHODS FOR ONE-CLICK VIDEO LIVE BROADCASTING VIA SPORTS CAMERA,” the contents of which are hereby incorporated by reference in its entirety.

### BACKGROUND

It has become more and more popular to use sports cameras to collect images of outdoor activities. After collecting these images, a user may want to share the collected images with friends, colleagues, or the public by live broadcasting or livestreaming. It could be challenging for a user, who has already been occupied with image-collecting tasks, to timely and properly share the collected images. It also can be challenging for the user to determine which route (e.g., via which social network or which account) to live broadcast and to decide who the viewer are (e.g., friends only or the public). To address such a need, a corresponding system should be easy to operate, convenient to carry, and can be operated in an intuitive/straightforward fashion. Therefore, it is advantageous to have a live broadcast system that can provide above-mentioned functions.

### BRIEF DESCRIPTION OF THE DRAWINGS

Embodiments of the disclosed technology will be described and explained through the use of the accompanying drawings.

FIG. 1 is a schematic diagram illustrating a system in accordance with embodiments of the disclosed technology.

FIG. 2 is a schematic diagram illustrating a sports camera system and a mobile device system in accordance with embodiments of the disclosed technology.

FIG. 3 is a schematic diagram illustrating a system in accordance with embodiments of the disclosed technology.

FIG. 4 is a schematic diagram illustrating a drone camera system in accordance with embodiments of the disclosed technology.

FIG. 5 is a flowchart illustrating a method in accordance with embodiments of the disclosed technology.

FIG. 6 is a flowchart illustrating a method in accordance with embodiments of the disclosed technology.

FIG. 7 is a flowchart illustrating a method in accordance with embodiments of the disclosed technology.

FIG. 8 is a flowchart illustrating a method in accordance with embodiments of the disclosed technology.

FIG. 9 is a flowchart illustrating a method in accordance with embodiments of the disclosed technology.

FIG. 10 is a flowchart illustrating a method in accordance with embodiments of the disclosed technology.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “some embodiment,” “one embodiment,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure relates to methods for live broadcasting a set of images (e.g., live stream images, video, etc.). The method includes receiving an instruction generated by a user clicking a button (e.g., a share button) on a first device (e.g., a sports camera, a smartphone, etc.) configured to capture/transmit images. The method includes suspending (or terminating) at least one existing application (e.g., a background application or an application that is consuming computing resources of the first device) and initiating a live broadcast application in the first device. The live broadcast application can then detect and choose a data transmission access route (from where the images are collected or stored, e.g., a sports camera, in some embodiments) to a remote live broadcast server based on connectivity, reliability and other suitable considerations. The method can then connect with the remote live broadcast server via the data transmission access route and send account information (e.g., user account names and passwords) to the remote live broadcast server for authentication. Once the authentication is completed, the remote live broadcast server sends a token to the first device. Based on the token, the user can then send a live broadcast request to the remote live broadcast server. The remote live broadcast server then sends back a data transmission address (e.g., a network address) to the user. Via the data transmission access route (e.g., directly from a sports camera to the remote server, or using a smartphone as a relay), the user can then transmit or upload live stream images to the data transmission address.

In some embodiments, the present technology enables the first device to detect compatible devices in a local network (e.g., a smartphone connected thereto via Bluetooth, infrared, Wi-Fi, etc.) that can be used to communicate with the remote live broadcast server. The compatible devices can also have the live broadcast application installed. The compatible devices can be labeled or identified as secondary image devices (e.g., as backup image collecting devices when the first device cannot collect desirable images for limited view angles or is low on battery). Once the compatible devices are identified or labeled, the method can accordingly form a set of multi-cam account information (e.g., User A has an account associated with two compatible devices—sports camera X and smartphone Y). The set of multi-cam account information can then be stored in the remote live broadcast server. Based on the set of multi-cam account information, the token can be sent to these identified or labeled compatible devices (so as to enable them to interact with the remote server based on the token).

In some embodiments, the identified or labeled compatible devices can be assigned or divided into two or more groups based on factors such as physical proximity (e.g., this can be dynamically updated), computing capacity, data transmission rates, user settings/preferences, etc. In some embodiments, the images collected from different compatible devices can be combined, incorporated, or edited before live broadcasting.

Another aspect of the present technology includes determining the data transmission access route based on the following factors: transmission rates/speeds, reliability, network connectivity, energy consumptions, and/or other suitable factors. The present technology can also identify a plurality of access points for the first device as candidate access points (e.g., Wi-Fi access points, 3G/4G access points, hotspots, etc.). When the first device needs to communicate with other devices (e.g., the remote live broadcast server), it can run one or more tests (e.g., speed, reliability, etc.) on these candidate access points so as to find suitable one(s) to carry out the communication task. In some embodiments, a user can select a suitable access point based on the result of the test(s). In some embodiments, these tests can be periodically performed and the results thereof can be frequently updated.

In some embodiments, the data transmission access route can be decided based on a set of rules. For example, the set of rules can relate to transmission speed/rates, user preferences, network reliability/connectivity, etc. In some embodiments, the data transmission access route can be dynamically adjusted. For example, a user can first start to live broadcast by a sports camera. Later, when he/she moves to a location where live broadcasting via his/her smartphone can have better transmission speed, the user can then switch to the smartphone for live broadcasting. In such embodiments, the remote live broadcast server can create an image buffer (e.g., to store images to be live broadcasted during switching or transition) so as to make sure a smooth switching or transition (namely, the image quality/transmission of the live broadcasting is not significantly affected by the switching or transition event).

The present disclosure relates to a system that can be used to timely and properly share collected/captured images via a live broadcast or livestream process. In some embodiments, the system includes a live broadcast server which is accessible to one or more user devices (e.g., a sports camera, a smartphone, a tablet, a notebook, a terminal computer, etc.) via a wireless network (e.g., a 3G/4G network, the Internet, etc.). The system enables a user to initiate a live broadcast process via one or more of the user devices. For example, the user can press a share button on his/her sports camera (which is capable of communicating with the live broadcast server via the wireless network) to initiate the live broadcast process, and the images to be live broadcasted can be collected by the same sports camera. In another example, the user can initiate a live broadcast process via a user interface of his/her smartphone, and the images to be live broadcasted can be collected by one or more sports cameras associated with a user account of the user (e.g., relationships between the sports cameras and the user accounts can be stored in the live broadcast server or a database coupled thereto). By this arrangement, the present technology provides a user with a convenient, flexible, and intuitive way to live broadcast images. In some embodiments, the present technology can detect a compatible device (e.g., a smart device, a sports camera, a smartphone, a pad, a computer, etc.) with a live broadcast application installed, so as to implement the present technology.

A representative live broadcast server system includes, inter alia, (1) a storage component configured to store a set of images to be live broadcasted; (2) a communication component configured to receive a set of account information (e.g., user login name/password); (3) an authentication component configured to authenticate a user account (e.g., a registered account in the live broadcast server system) based on the set of account information and information in an account database (e.g., a list of valid user accounts and associated information, such as a group of cameras associated with the user account, or a plurality of social network accounts associated with the user account); and (4) an account management component configured to manage the account database. The authentication component is also configured to generate a token (e.g., an encoded or encrypted certificate or other suitable data set) for initiating a live broadcast process after authenticating the user account. The token can be used to verify whether a request is from an authenticated user.

The account management component is configured to determine at least one authorized viewer based on the request. For example, in the request, the user may ask the live broadcasted images to be viewed by all of his/her friends in social network A, as well as all of his/her family members in social network B. Accordingly, the account management component can then determine who the authorized viewers should be. In some embodiments, the account management component can determine the authorized viewers by a stored user preference or history.

The account management component can also be configured to generate a network address (e.g., where the images to be uploaded) based on the received request or other factors such as storage availability, network reliability, bandwidth, transmission speed, etc. Once the network address is determined, the live broadcast server can generate a link associated with the network address and transmit the link to the user. The user can then use the link to upload the images to be live broadcasted via the network address.

The systems and associated methods in accordance with the present technology enable a user to initiate a live broadcast process in a flexible, safe, intuitive, and convenient fashion. Advantages of the present technology include providing a system that can effectively and efficiently manage multiple image devices and/or other devices via a network to perform a live broadcast task.

Another aspect of the present technology includes that it enables the images to be broadcasted coming from various image devices (e.g., a sports camera and a smartphone). The present technology can coordinate with these image devices and generate an incorporated or integrated set of images that can be live broadcasted. In some embodiments, the present technology also allows a user to “switch” image devices during a live broadcast procedure. For example, a user can first use his/her sports camera to collect images for live broadcasting for a period of time. Once the user finds that the sports camera is low on battery power, the user can immediately switch to his/her smartphone to keep collecting images for live broadcasting.

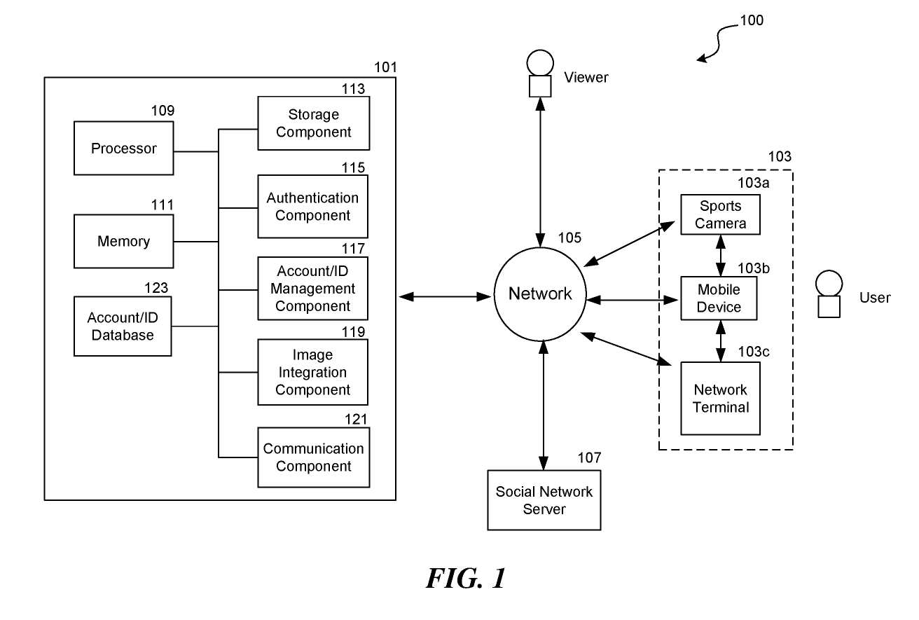

FIG. 1 is a schematic diagram illustrating a system 100 in accordance with embodiments of the disclosed technology. The system 100 includes a live broadcast server 101 and a plurality of user devices 103. Three representative devices are shown in FIG. 1, namely a sports camera 103a (e.g., a camera that is capable of capturing images of an object moving in relative high speed), a mobile device 103b (e.g., a smartphone, a tablet, a notebook, etc.), and a network terminal 103c (e.g., a desktop computer, a kiosk, etc.). In other embodiments, the user devices 103 can include different numbers/types of suitable devices. The user can communicate with the live broadcast server 101 by one of the user devices 103 via a network 105 (e.g., the Internet, an intranet, a local network, etc.). For example, the user can initiate a live broadcast process via the live broadcast server 101 by transmitting or uploading a set of images to be live broadcasted. A viewer can then access the set of images through the network 105. In some embodiments, the viewer can access the set of images via a social network server 107 (e.g., the live broadcast server 101 transmits the images to the social network server 107). In some embodiments, the viewer can access the set of images directly via the live broadcast server 101.

As shown in FIG. 1, the live broadcast server 101 includes a processor 109, a memory 111, a storage component 113, an authentication component 115, an account/identification management component 117, an image integration component 119, a communication component 121, and an account/identification database 123. The processor 109 is configured to control the memory 111 and other components (e.g., components 113-123) in the live broadcast server 101. The memory 111 is coupled to the processor 105 and configured to store instructions for controlling other components or other information in the live broadcast server 101.

The storage component 113 is configured to store, temporarily or permanently, information/data/files/signals associated with the live broadcast server 101. For example, the storage component 113 can store the images to be broadcasted transmitted by the user device 103. In some embodiments, the storage component 113 can have a distributed structure such that it can include multiple physical/virtual partitions across a network. In some embodiments, the storage component 113 can be a hard disk drive or other suitable storage means.

The authentication component 115 is configured to (1) authenticate a user account registered in the live broadcast server 101, and (2) generate a token for initiating a live broadcast process after authenticating the user account. The authentication component 115 can authenticate the user account by analyzing/verifying the account information (e.g., user name and password) provided by the user. In some embodiments, the authentication component 115 can compare the provided account information with a list of valid user accounts stored in the account/identification database 123. The authentication component 115 is also configured to generate a token (e.g., an encoded or encrypted certificate or other suitable data set) for initiating a live broadcast process after authenticating the user account. The token can be used to identify a request from an authenticated user. For example, in some embodiments, the live broadcast server can accept and process any request submitted with the token, no matter where the request comes from (e.g., the device submitting the request is not necessarily the same device requesting authentication and receiving the token). In other embodiments, the live broadcast server may require additional authentication when the device submitting the request is not the same as the one receiving the token.

The account/identification management component 117 is configured to (1) manage the account database 123; (2) determine authorized viewers for a live broadcast process; and (3) generate a network address for the live broadcast process. In some embodiments, the user can create a new account (or delete an existing one) in the live broadcast server 101 via the account/identification management component 117. The account/identification management component 117 can also determine the authorized viewer for a live broadcast process based on a request from an authenticated user. For example, in the request, the user may ask for a push service to push information of his/her live broadcast to all of his/her friends in social network A. In some embodiments, the account/identification management component 117 can determine the authorized viewers by a stored user preference (e.g., grant access to the public all the time) or user history (e.g., grant access to a viewer who has been granted access to a previous live broadcast before).

In some embodiments, the account/identification management component 117 can generate a network address (e.g., where the images to be uploaded) based on the received request. In some embodiments, the live broadcast server can have a distributed structure and include multiple storages/databases across a network. In such embodiments, the account management component can determine the network address by considering storage availability, network reliability/bandwidth/speed, and/or other suitable factors.

Once the network address is determined, the live broadcast server 101 can generate a link associated with the network address and transmit the link to the user. The user can then use the link to upload the images to be live broadcasted to the network address. In some embodiments, a further authentication may be required when uploading the images (e.g., the live broadcast server 101 may require the token generated by the authentication component 115).

The image integration component 119 can edit the images to be live broadcasted. In some embodiments, the image integration component 119 can generate the images to be live broadcasted by combining a first set of images uploaded from a first device (e.g., a sports camera) and a second set of images uploaded from a second device (e.g., a smartphone that is capable of collecting images). In some embodiments, the image integration component 119 can edit the images to be live broadcasted based on a set of rules. For example, a social network may have a specific requirement for image qualities when a user wants to live broadcast via that social network. As another example, a user may want to live broadcast a set of three-dimensional images that can be presented in a virtual reality (VR) environment. The image integration component 119 can be configured to address these needs above and other suitable ones.

The communication component 121 is configured to communicate with other devices (e.g., the user devices 103) and servers (e.g., the social network server 107) via the network 105. In some embodiments, the communication component 121 can be an integrated chip/module/component that is capable of communicating with multiple devices.

The account/identification database 123 can include information associated with the user accounts. For example, such information can includes: (1) User X's account is associated with a group of cameras, which are all authorized to collect images for live broadcasting; (2) User Y's account is associated with one account of social network A and two accounts of social network B. Each of the social network accounts can have particular privacy/security rules for live broadcasting (e.g., User Y does not allow images collected in a particular area to be live broadcasted via his/her account of social network A). Such information can be useful for the live broadcast server 101 to determine how to perform the live broadcast task.

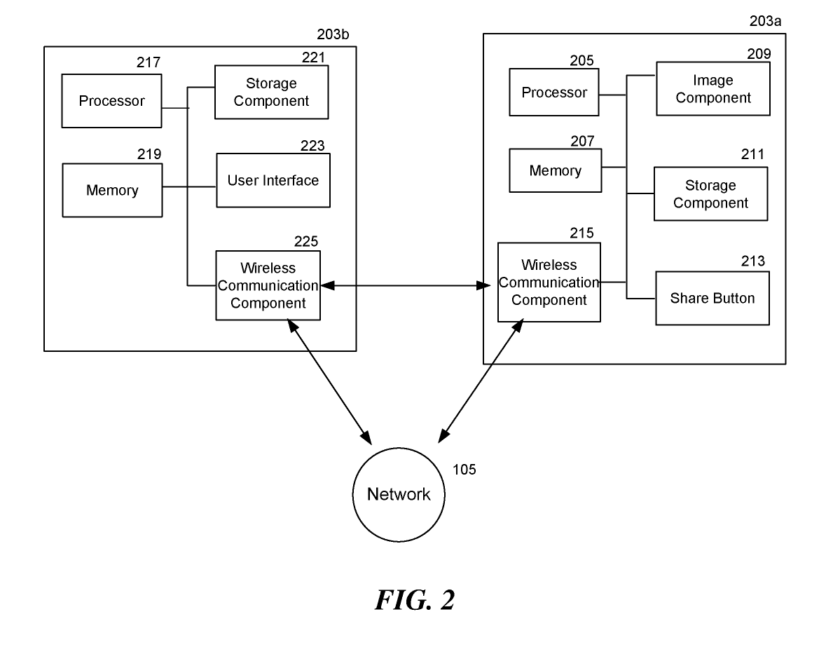

FIG. 2 is a schematic diagram illustrating a sports camera system 203a and a mobile device system 203b in accordance with embodiments of the disclosed technology. As shown, the sports camera system 203a can communicate with the mobile device system 203b under a relatively short-range communication protocol (e.g., Bluetooth, infrared, etc.). In some embodiments, the sports camera system 203a and the mobile device system 203b can communicate via the network 105 under relatively long-range communication protocol (e.g., 3G/4G, Wi-Fi, etc.). A relatively short-range communication can consume less energy than a relatively long-range communication. In some embodiments, when the sports camera system 203a and the mobile device system 203b are positioned in physical proximity, the sports camera system 203a and the mobile device system 203b can choose to communicate (e.g., to share tokens, to transmit images, to share account information, etc.) under the relatively short-range communication protocol.

As shown in FIG. 2, the sports camera system 203a includes a processor 205, a memory 207, an image component 209, a storage component 211, a share button 213, and a communication component 215. The processor 205 is configured to control the memory 207 and other components (e.g., components 209-215) in the sports camera system 203a. The memory 207 is coupled to the processor 205 and configured to store instructions for controlling other components or other information in the sports camera system 203a. The image component 209 is configured to capture or collect images (pictures, videos, etc.) to be live broadcasted from ambient environments of the sports camera system 203a. In some embodiments, the image component 209 can include an image sensor and a lens. In some embodiments, the image component 209 can be a video recorder. The storage component 211 is configured to store, temporarily or permanently, information/data/files/signals associated with the sports camera system 203a. In some embodiments, the storage component 211 can be a hard disk drive. In some embodiments, the storage component 211 can be a memory stick or a memory card. The share button 213 can be configured to receive a user's instruction (e.g., by clicking, hitting, moving, or rotating the share button 213) to initiate a live broadcast process. The communication component 215 is configured to communicate with other devices directly or via the network 105, as discussed above.

As shown in FIG. 2, the mobile device system 203b includes a processor 217, a memory 219, a storage component 221, a user interface 223, and a communication component 225. The processor 217 is configured to control the memory 219 and other components (e.g., components 221-225) in the mobile device system 203b. The memory 219 is coupled to the processor 217 and configured to store instructions for controlling other components or other information in the mobile device system 203b. The storage component 221 is configured to store, temporarily or permanently, information/data/files/signals associated with the mobile device system 203b. In some embodiments, the storage component 221 can be a hard disk drive. In some embodiments, the storage component 221 can be a memory stick or a memory card. The communication component 225 is configured to communicate with other devices directly or via the network 105, as discussed above. The user interface 223 is configured to interact with a user (e.g., to receive an instruction to initiate a live broadcast process). In some embodiments, the mobile device system 203b can also include an image component configured to collect images.

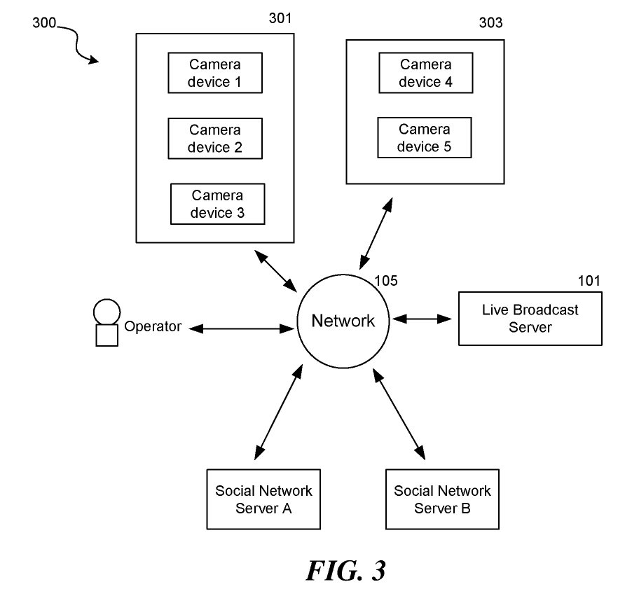

FIG. 3 is a schematic diagram illustrating a system 300 in accordance with embodiments of the disclosed technology. The system 300 enables an operator to control multiple cameras devices (e.g., a sports camera, a camera drone system, a smartphone capable of collecting images, etc.) directly (e.g., a user can directly operate a camera to initiate a live broadcast process by a “one-click” action) or via the live broadcast server 101. In the illustrated embodiment, the system 300 includes the live broadcast server 101, a first group of camera devices 301, and a second group of camera devices 303. As shown, the first group of cameras 301 includes camera devices 1-3, and the second group of camera devices 303 includes camera devices 4 and 5. In other embodiments, the system 300 can include different numbers of groups and/or camera devices.

The live broadcast server 101 can provide the operator with an integrated user interface to manage the camera devices 1-5 via the network 105. By connecting with (e.g., logging in) the live broadcast server 101, the operator can effectively and conveniently control the camera devices 1-5 via a user interface presented by a user device (e.g., the sports camera 103a, the mobile device 103b, or the network terminal 103c) to perform multi-cam live broadcast tasks. For example, in some embodiments, the operator can instruct the first group of camera devices 301 (i.e., camera devices 1-3) to collect images and then transmit the collected images to the live broadcast server 101. The live broadcast server 101 can combine these images and then send them to social network server A for live broadcasting.

In some embodiments, the operator can instruct the second group of camera devices 303 (i.e., camera devices 4 and 5) to collect images and then transmit the collected images to the live broadcast server 101. The live broadcast server 101 can combine these images and then send them to social network server B for live broadcasting.

In some embodiments, the operator can instruct both the first group of camera 301 (i.e., camera devices 1-3) and the second group of camera 303 (i.e., camera devices 4 and 5) to collect images and then transmit the collected images to the live broadcast server 101. The live broadcast server 101 can combine these images and then perform a live broadcast task itself.

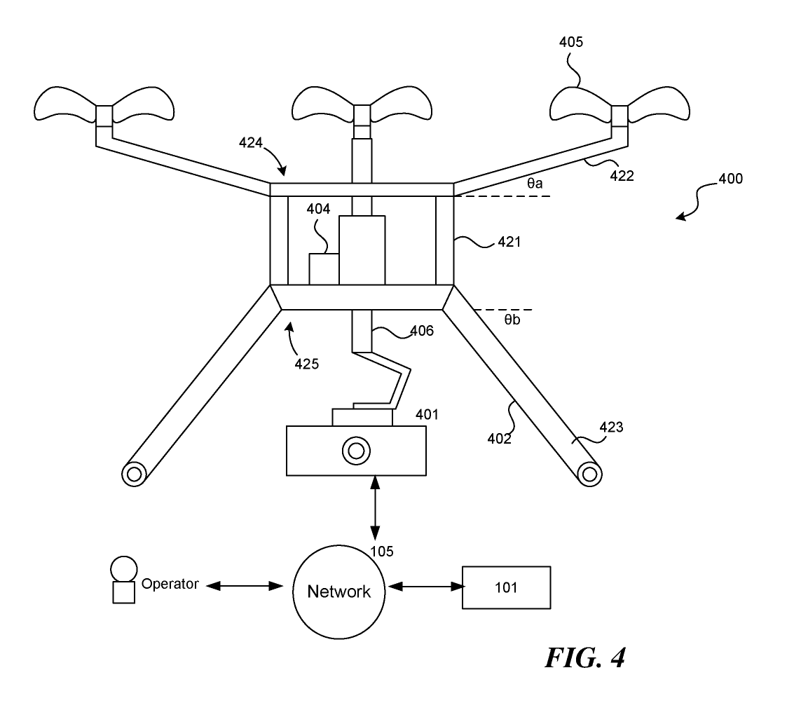

FIG. 4 is a schematic diagram illustrating a drone camera system 400 in accordance with embodiments of the disclosed technology. The drone camera system can be controlled by an operator by the live broadcast server 101 via the network 105. As shown, the camera drone system 400 includes a camera device 401, a support structure 402, a drone controller 404, multiple rotor wings 405, and a camera connector 406. The support structure 402 includes a center frame portion 421, multiple arm components 422, and multiple leg components 423. The center frame portion 421 is configured to support the drone controller 404. In some embodiments, the drone controller 404 can be coupled to the center frame portion 421.

The arm components 422 are configured to support the rotor wings 405. In some embodiments, each arm component 422 is configured to support a corresponding one of the rotor wings 405. In some embodiments, the arm components 422 are positioned circumferentially around the center frame portion 421. As shown in FIG. 4, each of the arm components 422 is positioned to form a first angle θₐ with an upper surface 424 of the center frame portion 421. In other embodiments, however, individual arm components 422 can be positioned to form different first angles with the upper surface 424 of the center frame portion 421. The leg components 423 are configured to support the camera drone system 400 when it is placed on the ground. In some embodiments, the leg components 423 can be positioned so as to protect the camera 401 from possible impact caused by other objects (e.g., a bird flying near the drone camera system 400 during operation).

In some embodiments, the leg components 423 can be positioned circumferentially around the center frame portion 421. As shown in FIG. 4, each of the leg components 423 is positioned to form a second angle θ_{b} with a lower surface 425 of the center frame portion 421. In the illustrated embodiment shown in FIG. 4, the second angle θ_{b} is greater than the first angle θₐ. In other embodiments, the second angle θ_{b} can be smaller than or equal to the first angle θₐ. In some embodiments, the first angle θₐ can be about 30 degrees, and the second angle θ_{b} can be about 45 degrees.

As shown in FIG. 4, the camera device 401 is fixedly or rigidly coupled to the center frame portion 421 by the camera connector 406 (e.g., the camera device 401 does not rotate relatively to the center frame portion 421). In the illustrated embodiment, the camera connector 406 is a U-shaped member. In some embodiments, the camera connector 406 can function as a damper so as to protect the camera device 401 from undesirable vibration caused by the rotor wings 405.

The camera device 401 is configured to interact with the live broadcast server 101 via the network 105. The operator can control the camera device 401 via the live broadcast server 101. The present technology provides a convenient and flexible way for the operator to control the camera device 401. For example, a designated pilot can control the movement of the camera drone system 400, while the operator (e.g., a director of a film) can keep observing the images collected by the camera device 401 (e.g., the collected images are periodically or continuously sent to the operator for review via the live broadcast server 101 and the network 105). Then the observer can decide when to initiate a live broadcast process (or stop the same). The present technology provides flexibility regarding how to control the camera device 401 and also enables a user to timely and properly share collected images.

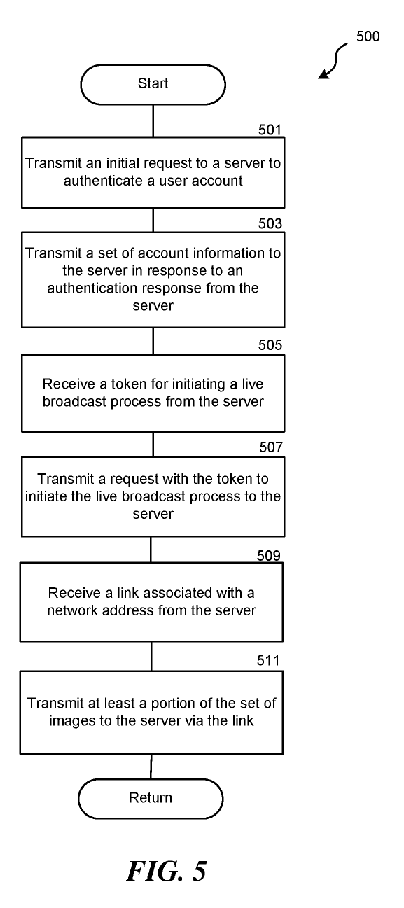

FIG. 5 is a flowchart illustrating a method 500 in accordance with embodiments of the disclosed technology. The method 500 can be implemented by a user device (e.g., the user device 103). The method 500 starts at block 501 by transmitting an initial request to a server to authenticate a user account. At block 503, the method 500 continues to transmit a set of account information to the server in response to an authentication response from the server. At block 505, the method 500 then receives a token for initiating a live broadcast process from the server. At block 507, the method 500 transmits a request with the token to initiate the live broadcast process to the serve. The method 500 continues to block 509 by receiving a link associated with a network address from the server. At block 511, the method 500 then transmits at least a portion of the set of images to the server via the link. The method 500 then returns.

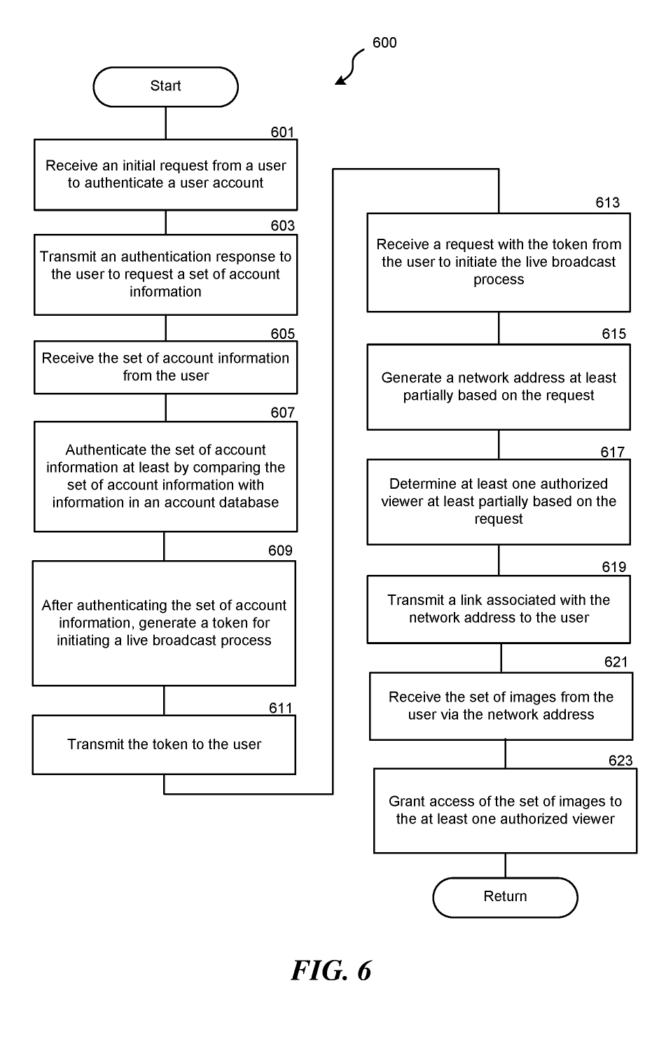

FIG. 6 is a flowchart illustrating a method 600 in accordance with embodiments of the disclosed technology. The method 600 can be implemented by a live broadcast server (e.g., the live broadcast server 101). At block 601, the method 600 receives an initial request from a user to authenticate a user account. At block 603, the method 600 continues by transmitting an authentication response to the user to request a set of account information. The method 600 then, at block 605, receives the set of account information from the user.

At block 607, the method 600 proceeds to authenticate the set of account information at least by comparing the set of account information with information in an account database. After authenticating the set of account information (e.g., the user account is valid, not expired, etc.), the method 600 then generate a token for initiating a live broadcast process at block 609. The method 600 continues to block 611 by transmitting the token to the user.

At block 613, the method 600 receives a request with the token from the user to initiate the live broadcast process. In some embodiments, the request is not sent by the user device that originally sends the initial request for authentication. As long as the token is valid (e.g., not expired), the method 600 can proceed to block 615. If the token is not valid or expired, the method 600 can stop or simply stand by for further actions. At block 615, the method 600 then generates a network address at least partially based on the request. At block 617, the method 600 determines at least one authorized viewer at least partially based on the request. At block 619, the method 600 then transmits a link associated with the network address to the user.

Once the user get the link, the user knows where to transmit or upload the set of images to be live broadcasted. At block 621, the method 600 receives the set of images from the user via the network address. At block 623, the method 600 grants access of the set of images to the at least one authorized viewer. The method 600 then returns.

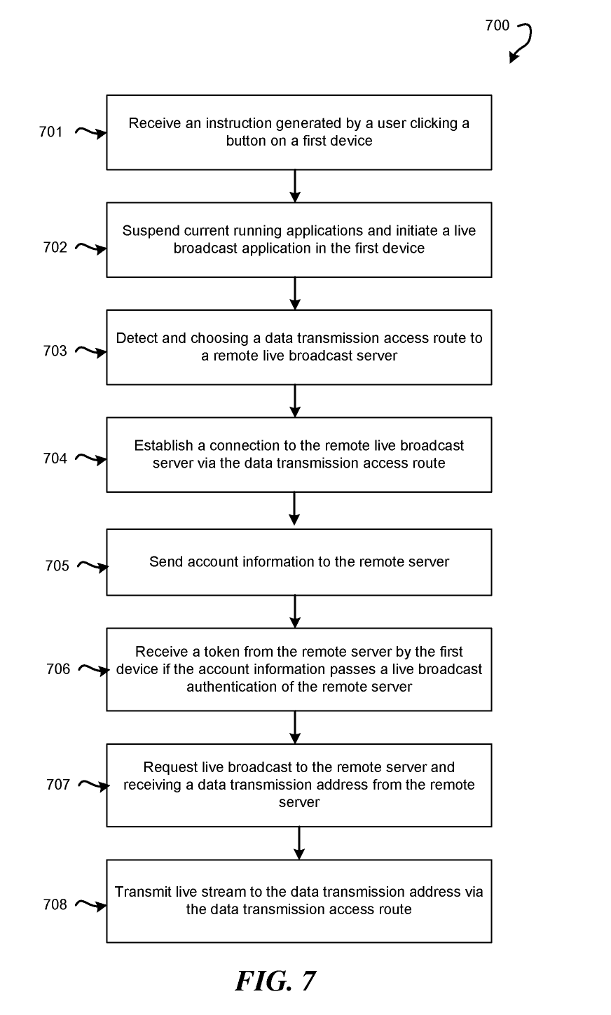

FIG. 7 is a process flow diagram of a method 700 for live broadcasting a set of live stream (e.g., a series of information or network packages associated a set of images collected by a camera) in accordance with embodiments of the disclosed technology. As shown in FIG. 7, the method 700 is initiated at step 701 by receiving an instruction generated by a user clicking a button on a first device. The first device is configured to capture and transmit live stream. In one embodiment, the first device includes a sports camera. However, in other embodiments, the first device may be a smart device with a camera component/module/lens, for instance, a smart phone, a tablet or a laptop computer. The term “clicking” in this text can refer to any types of manipulation by a finger, such as hitting, touching, pressing, pushing, etc. The button may be a physical button positioned in a hull (or housing) of a sports camera in one embodiment, or may be a virtual button on a displayed user interface of a touch screen in another embodiment.

Step 702 is to suspend (or terminate, in some embodiment) currently running applications (or background applications, in some embodiments) and initiate a live broadcast application on the first device. In one embodiment, suspending current running applications is forcing to halt the current running applications, and in another embodiment, suspending current running applications is to set the application running in background.

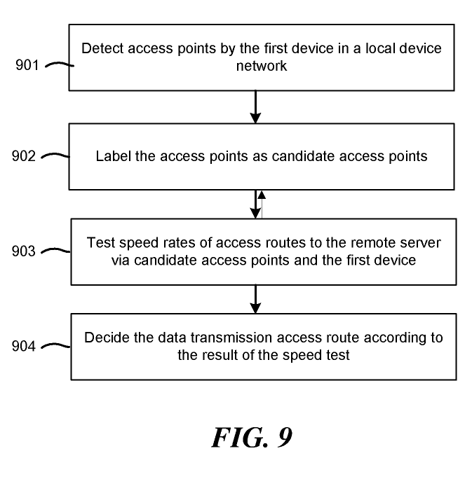

Step 703 is to detect and select a data transmission access route to a remote live broadcast server. The detailed process of this step will be described in embodiments depicted by FIG. 9.

Step 704 is to establish a connection to the remote live broadcast server via the data transmission access route. At this step, the connection may be established according to the TCP (Transmission Control Protocol) 3-way handshake protocol or according to a private handshake protocol. When a connection is successfully established, the next step 705 is to send account information to the remote server. The account information may be a user name and an associated password for the remote server recorded on the first device (referred to as “account information of the first device” in the following text). However, in another embodiment, the account information may further comprise a set of accounts (including user name and password) associated with the remote live broadcast server and a plurality of other social websites. In yet another embodiment, the method 700 can be implemented under a multi-cam live broadcast circumstance (e.g., live broadcasting via more than two cameras). The account information can be a set of multi-cam account information, and may further comprise a set of accounts associated with the user information on the first device and the user information on a plurality of other camera devices for a multi-cam live broadcast.

After then, step 706 is to receive a token from the remote server by the first device if the account information passes a live broadcast authentication of the remote server. In one embodiment, the live broadcast is a single camera live broadcast mode, and the remote server returns a single token to the first device. In another embodiment, the live broadcast is under a multi-cam live broadcast mode, and the remote server returns a set of tokens to the first device. The number of the set of tokens depends on the number of the devices participating in the live broadcast, and each of the token is associated with a device. In yet another embodiment, the live broadcast is under a multi-cam live broadcast mode, and the remote server returns a unified token to the first device. The unified token contains the set of multi-cam account information for every device participating into the live broadcast.

At step 707, a request for live broadcast is sent to the remote server and the remote server returns a data transmission address after authenticating that the initiator of the request is permitted to conduct a live broadcast based on the account information. In one embodiment, the data transmission address is an access path to a portion of storage space of the remote server. In some embodiments, the server may further request a third party cloud storage service to generate the data transmission address. In such embodiments, the data transmission address can be an access path to a cloud storage space of the third party cloud storage service.

In some embodiments, if the account information comprises a set of accounts associated with the remote live broadcast server and a plurality of other social websites, the data transmission address can comprise a set of uniform resource locator (URL) links. The URL links can be respectively associated with the plurality of other social websites. The URL links may be requested by the remote server according to the account information.

At step 708, a live broadcast begins, and a set of live stream is transmitted to the data transmission address via the data transmission access route.

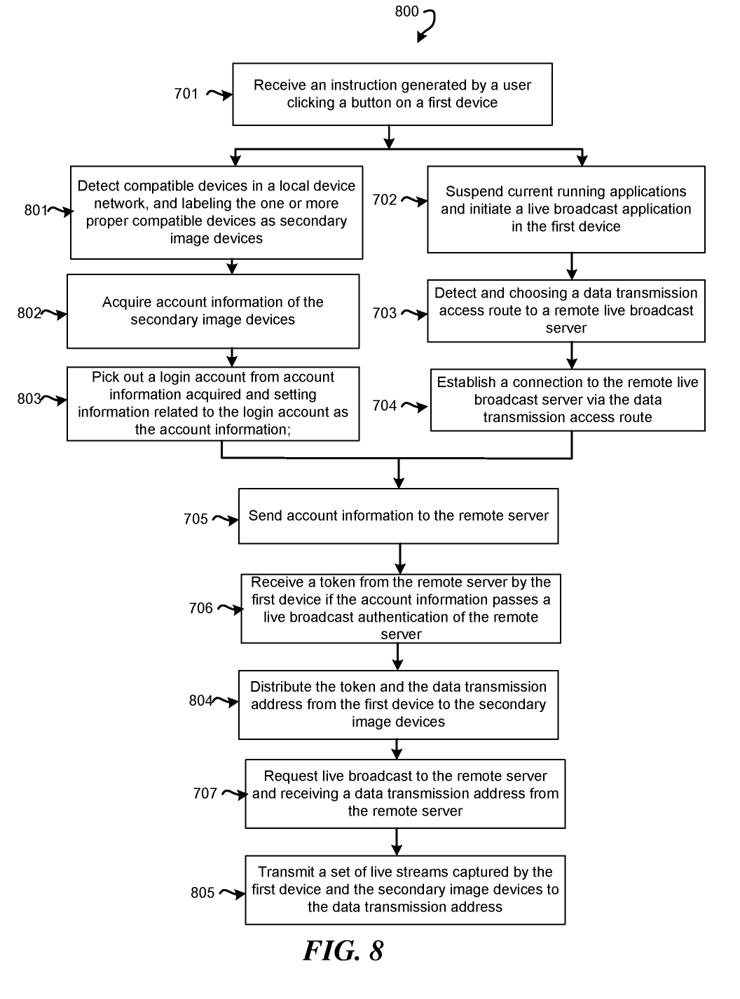

FIG. 8 illustrates a process flow diagram of a method 800 for live broadcasting a set of live stream in accordance with some other embodiments of the disclosed technology. As shown in FIG. 8, the method 800 is for multi-cam live broadcast mode. Compared with the method 700, the method 800 further comprises a step 801 of detecting compatible devices by the first device in a local device network according to user setting. If one or more compatible devices are detected and configured to capture and transmit live stream, the method 800 then labels the one or more compatible devices as secondary image devices. In the illustrated embodiment, this step is synchronously performed with step 702. However, this step could be performed synchronously with, before, or behind step 702, 703 or 704 in certain embodiments. The local device network which the first device and secondary image devices could access may be Wi-Fi network, ZigBee network, Bluetooth network, infrared network or any other suitable local area network (LAN). The local device network may be generated by the first device, the compatible devices or other nearby devices. The compatible devices may be sports cameras, conventional cameras, smart phones, tablets, laptop computers etc. In one embodiment, the detection is performed by the live broadcast application on the first device. The same live broadcast application can also be installed in the compatible devices and thus could the compatible devices can respond to the detection. The first device and the secondary devices may be further divided into one or more image groups for live broadcast.

When the secondary image devices are detected, at step 802, the first device begins to acquire account information from the one or more secondary image devices. In one embodiment, the first device may acquire the account information by scanning a Quick Response (QR) code displayed on the one or more secondary image devices. In another embodiment, the first device may acquire the account information by communicating with the secondary image devices via the local device network.

At step 803, a login account is picked out from the account information acquired from the secondary image devices. The account information of the first device and information related to the login account is then set as the account information.

In an alternative embodiment, the account information of the secondary image devices and the account information of the first device are combined to form a set of multi-cam account information and then the set of multi-cam account information is sent to the remote server. The set of multi-cam account information comprises a set of accounts associated with the user information on the first device and the user information on the secondary image devices. When the remote server receives the set of multi-cam account information, the remote server will authenticate if the accounts contains in the set of multi-cam account information could be authorized to login in and initiate a live broadcast. If one or more accounts pass the live broadcast authentication, the remote server will return the set of tokens or the unified token to the first device.

Continuing to FIG. 8, at step 804, the token (either the set of tokens or the unified token) and the data transmission address are distributed from the first device to the secondary image devices. At step 805, when the live broadcast begins, a set of live streams captured by the first device and the secondary image devices is transmitted to the data transmission address via the local device network and the data transmission access route. In one embodiment, the set of live streams is generated from at least one of the image group.

Transmitting the set of live streams may further comprise: capturing a first portion of the set of live streams by a first device; and capturing a second portion of the set of live streams by one of the secondary image device to the first device; transmitting the second portion of the set of live streams to the first device; labeling the first portion of the set of live streams; labeling the second portion of the set of live streams; and generating and transmitting the set of live streams at least partially based on the first portion of the set of live streams and the second portion of the set of live streams. When the remote server receives the set of live streams, it could classify process and present images according to the labels on the portions of the set of live streams.

FIG. 9 illustrates a detailed process of detecting and selecting a data transmission access route to a remote live broadcast server involving multiple access points in accordance with some embodiments of the disclosed technology. As shown in FIG. 9, at step 901, the first device detects access points in the local device network. The access points may be generated from compatible devices with the live broadcast application installed. For example, the access points can be generated by a sports camera, smart phone, tablet, laptop computer, wireless router, wireless network switch, etc. As an example, when performing a multi-cam live broadcast, each of the secondary image devices may generate an access point if the secondary image devices have network adapters capable of connecting with the remote server.

At step 902, if one or more access points are found able to be connected by the first device and to access the remote server, these access points are labeled as candidate access points.

Then at step 903, a speed test is performed to test the speed rate of the access routes to the remote server via the candidate access points and the first device. The speed test may comprise both network latency and bandwidth.

For instance, suppose that there are a first device and a secondary image device for a live broadcast, and that both devices are capable of connecting with each other and visiting the remote server independently. Then the secondary image device can be labeled as a candidate access point. A first access route is that all live streams are transmitted to the remote server via the first device, wherein a portion of live stream captured by the secondary image device is transmitted to the first device, and then retransmitted to the remote server by the first device. A second access route can be that all live streams are transmitted to the remote server from the secondary image device, wherein a portion of live stream captured by the first device is transmitted to the secondary image device, and then retransmitted to the remote server by the secondary image device. During the speed test, the bandwidth and the network latency of the first access route and the second access route are compared.

At step 904, the data transmission access route is decided according to the result of the speed test. In one embodiment, options of access points and the result of the speed test are presented to a user. The data transmission access route is set according to user selection.

In other embodiments, the data transmission access route is decided automatically according to a route selecting rule. In one embodiment, the route selection rule can be that: if a bandwidth of the fastest access route to the remote server via the candidate access points (e.g., 300 Mbps) is larger than a bandwidth of the access route to the remote server via the first device (e.g. 150 Mbps) by a bandwidth threshold (e.g., 50 Mbps), the process can select the fastest access route via the candidate access points as the data transmission access route. Otherwise, the method can choose the access route via the first device as the data transmission access route (e.g., the bandwidth of the access route via the first device is 270 Mbps, and the bandwidth of access route via the fastest candidate access point is remaining 300 Mbps).

In other embodiments, the route selection rule may be set according to the measurement of network latency (e.g., measuring a packet of data to get from one designated point to another).

In some embodiments, during the live broadcast, the speed test can continuously or periodically performed during the transmission of the live stream. When the route selection rule is satisfied, the data transmission access route can be switched accordingly. For instance, suppose that the access route via the first device is decided as the original data transmission access route and the route selection rule is the rule described foregoing. When the bandwidth of a new access route via the fastest candidate access point is 60 Mbps larger than the original access router via the first device, the data transmission access route will be switched to the new access route via the fastest candidate access point.

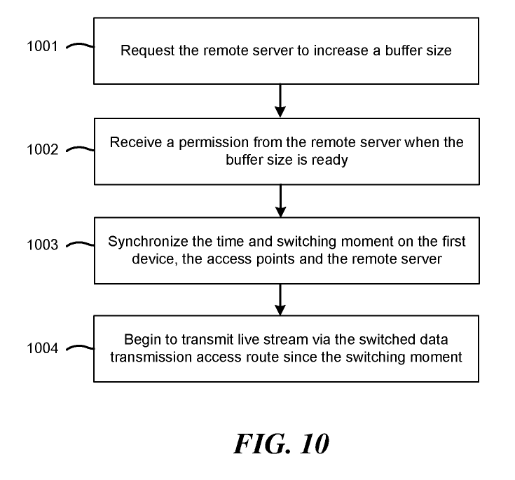

FIG. 10 illustrates a process of switching a data transmission access route in accordance with some embodiments of the disclosed technology. In FIG. 10, the process comprises step 1001, where the process requests the remote server to increase a buffer size of the live stream. At step 1002, the process receives permission from the remote server when the buffer size is ready. At step 1003, the process synchronizes the time and switching moment on the first device, the access points and the remote server. At step 1004, the process begins to transmit live stream via the switched data transmission access route since the switching moment.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A method for live broadcasting a set of live stream, comprising:
receiving an instruction generated by a user clicking a button on a first device, wherein the first device is configured to capture and transmit live stream;
suspending currently running applications and initiating a live broadcast application in the first device;
detecting and choosing a data transmission access route to a remote live broadcast server;
establishing a connection to the remote live broadcast server via the data transmission access route;
sending account information to the remote live broadcast server;
receiving a token from the remote live broadcast server by the first device if the account information passes a live broadcast authentication of the remote live broadcast server;
transmitting a live broadcast request to the remote live broadcast server and receiving a data transmission address from the remote live broadcast server; and
transmitting the set of live stream to the data transmission address via the data transmission access route.

2. The method of claim 1, further comprising:
detecting compatible devices by the first device in a local device network according to a user setting;
if one or more compatible devices are detected and are configured to capture and transmit live stream, labeling the detected compatible devices as secondary image devices;
acquiring account information of the secondary image devices;
picking out a login account from the account information acquired from the secondary image devices and the account information of the first device, and setting information related to the login account as the account information;
distributing the token and the data transmission address from the first device to the secondary image devices; and
transmitting the set of live stream captured by the first device and the secondary image devices to the data transmission address via the local device network and the data transmission access route.

3. The method of claim 2, wherein the secondary image devices and the first device are assigned into one or more image groups.

4. The method of claim 3, wherein the set of live stream is generated from at least one of the image group.

5. The method of claim 2, wherein transmitting the set of live stream images comprises:
capturing a first portion of the set of live stream by the first device;
capturing a second portion of the set of live stream by one of the secondary image devices;
transmitting the second portion of the set of live stream to the first device;
labeling the first portion of the set of live stream;
labeling the second portion of the set of live stream; and
generating and transmitting the set of live stream at least partially based on the first portion of the set of live stream and the second portion of the set of live stream.

6. The method of claim 1, wherein detecting and choosing the data transmission access route comprises:
detecting access points by the first device in a local device network;
if one or more access points are able to be connected by the first device and to access the remote live broadcast server, labeling the access points as candidate access points;
testing speed rates of access routes to the remote live broadcast server via the candidate access points and the first device; and
deciding the data transmission access route according to the result of the speed test.

7. The method of claim 6, wherein deciding the data transmission access route according to the result of the speed test comprising:
presenting the candidate access points and the result of the speed test to the user; and
setting the data transmission access route according to a user selection.

8. The method of claim 6, wherein deciding the data transmission access route is based on a route selection rule, and wherein the route selection rule comprises:
according to the result of the speed test, if a first speed rate of the fastest access route to the remote live broadcast server via the candidate access points is faster than a second speed rate of the access route to the remote live broadcast server via the first device, selecting the fastest access route via the candidate access points as the data transmission access route; and
if the first speed rate is not faster than the second speed rate, choosing the access route via the first device as the data transmission access route.

9. The method of claim 8, further comprising:
periodically testing speed rates of access routes to the remote live broadcast server via the candidate access points and the first device; and
switching the data transmission access route according to the route selection rule.

10. The method of claim 9, wherein switching the data transmission access route comprises:
requesting the remote live broadcast server to increase a buffer size;
receiving a permission from the remote live broadcast server after the buffer size is set;
synchronizing the time on the first device, the access points and the remote live broadcast server; and
beginning to transmit live stream via a switched data transmission access route since a switching moment.

11. The method of claim 6, wherein the candidate access points are generated from compatible devices and wherein the compatible devices are configured to capture live stream.

12. The method of claim 1, wherein the data transmission address comprises a set of uniform resource locator (URL) links, and wherein the URL links are respectively associated with different social networks.

13. A system for live broadcasting a set of live stream, the system comprising:
a processor;
a storage component coupled to the processor and configured to store the set of images;
a communication component coupled to the processor and configured to receive a set of account information;
an authentication component coupled to the processor and configured to authenticate a user account at least partially based on the set of account information and information in an account database coupled to the authentication component, the authentication component being configured to generate a token for initiating a live broadcast process after authenticating the user account, wherein the token is used to identify a request from an authenticated user; and
an account management component coupled to the processor and configured to generate a network address at least partially based on the request, the account management component being configured to determine at least one authorized viewer at least partially based on the request;
wherein a link associated with the network address is transmitted to the authenticated user;
wherein at least a portion of the set of the images is transmitted to the storage component via the communication component and the link associated with the network address; and
wherein the set of images is accessible to the at least one authorized viewer.

14. The system of claim 13, further comprising:
an image integration component coupled to the processor and configured to generate the set of images at least partially based on a first portion of the set of images and a second portion of the set of images.

15. The system of claim 14, wherein the first portion of the set of images is generated by a first device, and wherein the second portion of the set of images is generated by a second device different than the first device.

16. The system of claim 13, wherein the account management component is configured to manage the information in the account database, and wherein the information in the account database includes a list of one or more valid user accounts and a list of social network accounts associated with the one or more valid user accounts.

17. The system of claim 16, wherein each of the one or more valid user accounts is associated with a group of image devices.

18. A system for live broadcasting a set of live stream, comprising:
a button configured to receive an instruction generated by a user clicking the button;
a processor coupled to the button configured to, in response to the instruction:
suspend at least one existing applications;
initiate a live broadcast application in the first device;
detect and choose a data transmission access route to a remote live broadcast server;
establish a connection to the remote live broadcast server via the data transmission access route;
sending account information to the remote live broadcast server;
receive a token from the remote live broadcast server by the first device if the account information passes a live broadcast authentication of the remote live broadcast server;
transmit a live broadcast request to the remote live broadcast server and receive a data transmission address from the remote live broadcast server; and
transmit the set of live stream to the data transmission address via the data transmission access route.

19. The system of claim 18, wherein the processor is further configured to:
detect compatible devices by the system in a local device network according to a user setting;
label the detected compatible devices as secondary image devices based on the user setting;
acquire account information of the secondary image devices;
pick out a login account from the account information acquired from the secondary image devices and the account information of the first device;
set information related to the login account as the account information;
distribute the token and the data transmission address from the first device to the secondary image devices; and
transmit the set of live stream captured by the first device and the secondary image devices to the data transmission address via the local device network and the data transmission access route.

20. The system of claim 19, wherein the processor is further configured to:
capture a first portion of the set of live stream by the first device;
capture a second portion of the set of live stream by one of the secondary image devices;
transmit the second portion of the set of live stream to the first device;
label the first portion of the set of live stream;
label the second portion of the set of live stream; and
generate and transmit the set of live stream at least partially based on the first portion of the set of live stream and the second portion of the set of live stream.
